(19) United States
(12) Patent Application Publication
(10) Pub. No.: US 2003/0136635 A1
(43) Pub. Date: Jul. 24, 2003

(54) Handrail vertical load detector

(76) Inventor: Richard Lauch, Hopatcong, NJ (US)

Correspondence Address: Jay A. Bondell, Esq., SCHWEITZER CORNMAN GROSS & BONDELL LLP, 292 Madison Avenue, New York, NY, 10017, US

(21) Appl. No.: 10/039,099

(22) Filed: Jan. 4, 2002

(51) Int. Cl. B65G 43/02

(52) U.S. Cl. 198/335; 198/323

(57) ABSTRACT

An escalator handrail load monitoring and detection apparatus monitors and detects variations to a load applied to the handrail during operation. A distortable element is mounted to a handrail guide upon which the handrail rides and responds through distortions to downward-applied forces to the handrail. An electrical switch is activated by the distortion, allowing an output signal to be generated indicating that a particular minimum downward force has been applied to the handrail. The minimum force may be chosen to be above the range of forces normally applied to the handrail during normal passenger use, and thus be responsive to unsafe or improper operating conditions, such as when a passenger sits on the handrail or places packages thereon.

The present invention relates to a new and improved apparatus for monitoring and detecting variations to the load applied to an escalator handrail and the like.

### BACKGROUND OF THE INVENTION

Conventional escalator constructions utilize pairs of moving handrails extending along the length of the escalator and positioned at the sidewalls or balustrades thereof. In normal operation, the handrails are grasped by the passenger for balance and support purposes while on the escalator. In an emergency condition the handrail may be used to support a passenger who has lost his or her balance and is using the handrail to support most of his or her body weight. The handrail may also be used as a leverage point when a passenger is attempting to free an obstruction, such as when an article of clothing has become caught between the moving steps and fixed skirt of the escalator. The handrails may be improperly utilized for the support of packages or for sitting upon by a rider. In each of these situations the force applied to the handrail exceeds that which is normally contemplated or experienced.

There have heretofore been devices which attempt to identify unsafe or emergency situations by referencing or monitoring handrail operation. For example, published Japanese application 1203483 of Hitachi Ltd. discloses an optical-based system utilizing cameras which monitor the handrail and surrounding space. Image processing detects intrusions into the monitored space and generates an appropriate signal.

Published European Patent Application 960847 to the assignee of the present invention discloses a system that utilizes an inductive proximity switch to monitor the position of the escalator handrail with respect to the associated balustrade. If the handrail comes within a predetermined distance of the balustrade, a fault signal is established.

While the prior art offers methods to monitor the handrail, the solutions require either complex processing equipment or are not entirely feasible for the accurate monitoring of extended lengths of handrail.

It is accordingly a purpose of the present invention to provide a handrail monitoring apparatus capable of detecting a variety of handrail forces.

A further purpose of the present invention is to provide a handrail force sensor system that is capable of detecting forces at various locations along the length of a handrail.

Yet a further purpose of the present invention is to provide a handrail force sensor that is economical in construction and efficient in operation.

### BRIEF DESCRIPTION OF THE INVENTION

In accordance with the foregoing and other benefits and features, the present invention comprises a series of deformable elements extending along the length of the handrail sought to be monitored and positioned between the handrail and a fixed handrail guide. A low-friction coating or covering may be applied to the deformable elements at the point of contact between the deformable elements and the handrail. Electrical switches are associated with the deformable elements such that, when a deformable element is distorted as a result of a downward force being applied to the deformable element through the handrail in excess of a predetermined minimum, the electrical switch changes state, allowing a signal to be generated indicating an emergency condition. Appropriate processing circuitry can be provided to monitor switch actions and provide a supervisory function in connection therewith.

### BRIEF DESCRIPTION OF THE DRAWINGS

A fuller understanding of the present invention will be established upon consideration of the following detailed description of a preferred, but nonetheless illustrative embodiment of the present invention, when reviewed in association with the annexed drawings, wherein:

FIG. 1 is a perspective view of a portion of an escalator installation with which the present invention is employed;

FIG. 2 is a section view taken along line 2-2 of FIG. 1 depicting a section of the handrail and balustrade with the invention installed;

FIG. 3 is a view taken along line 3-3 of FIG. 2; and

FIG. 4 is a block diagram of the electrical circuitry for the invention.

### DETAILED DESCRIPTION OF THE INVENTION

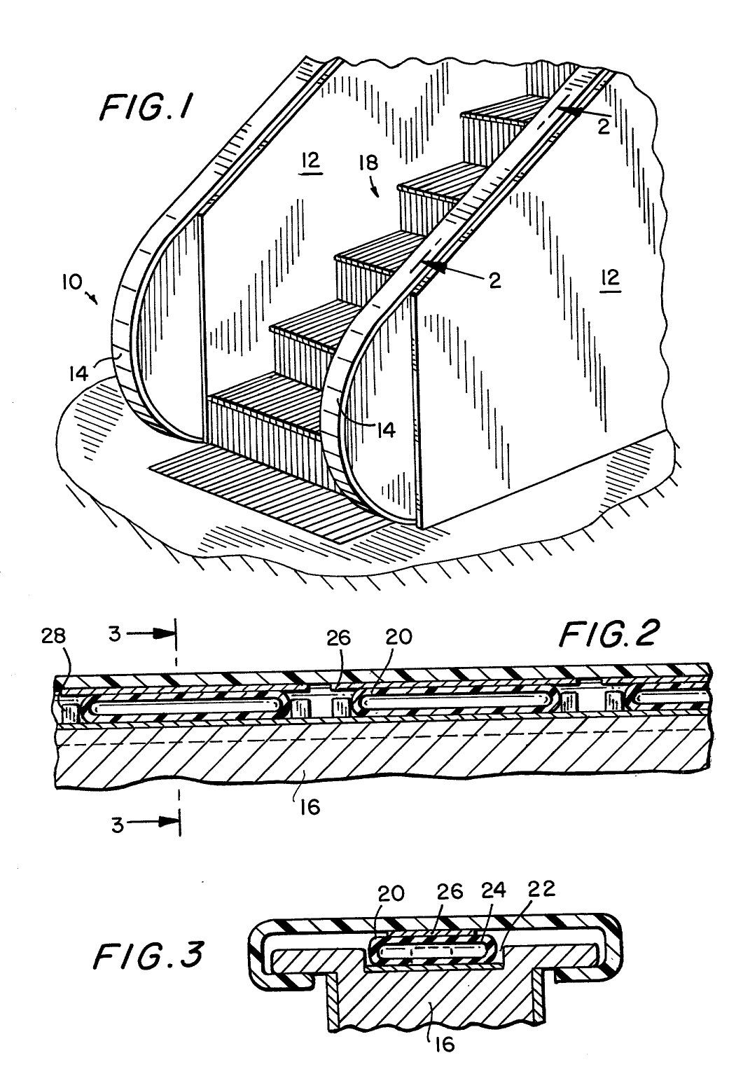

With initial reference to FIG. 1, escalator 10 includes a moving staircase 18 bounded on its sides by upstanding balustrades 12. Moving handrails 14 are located at the tops of the balustrades, and form a pair of continuous handrail loops driven in synchronism with the moving staircase 18.

As depicted in FIGS. 2 and 3, each handrail is generally supported by a balustrade-mounted handrail guide 16, which may be of a general T-shaped construction, with the handrail 14 being of a molded construction to wrap around the top of the guide. The present invention comprises a series of elongated deformable/compressible elements 20 mounted in a recess 22 which may be centrally located in the top of the handrail guide 16 and extends along the length thereof commensurate with the length of the handrail for which handrail monitoring is to be performed. The deformable elements 20 may each be, for example, about 2 feet long and may be in the form of a hollow, sealed elastomeric bladder having a generally flat top surface 24. When a downward force is applied to the top surface the bladder deforms, as will be further explained herein. A low-friction cover or coating, such as a thin stainless steel plate 26, may be affixed to the top surface of the bladder to protect the bladder and provide a low-friction contact between the moving handrail and the bladder. The bladder may be secured within the recess 22 by use of an appropriate adhesive. The plate 26 may also serve to distribute the applied handrail force across the top surface of the bladder.

Electrical switches 28 are also mounted within the recess 22, and are adapted and positioned to be actuated by the displacement of the deformable elements resulting from the downward application of a handrail force thereto. As depicted in the drawings, a pair of switches 28 may be located at opposite ends of each bladder 20 to compensate for potentially unbalanced distortion of the bladder, dependent upon the location at which the force is applied to the bladder and the travel of the point of contact with the handrail. The switches may be responsive to, for example, a physical elongation of the bladder upon distortion. Alternatively, other type of switches, responsive to the reaction of the deformable element to the applied handrail force, can be used, such as an internally mounted switch, responsive to an increase in internal pressure.

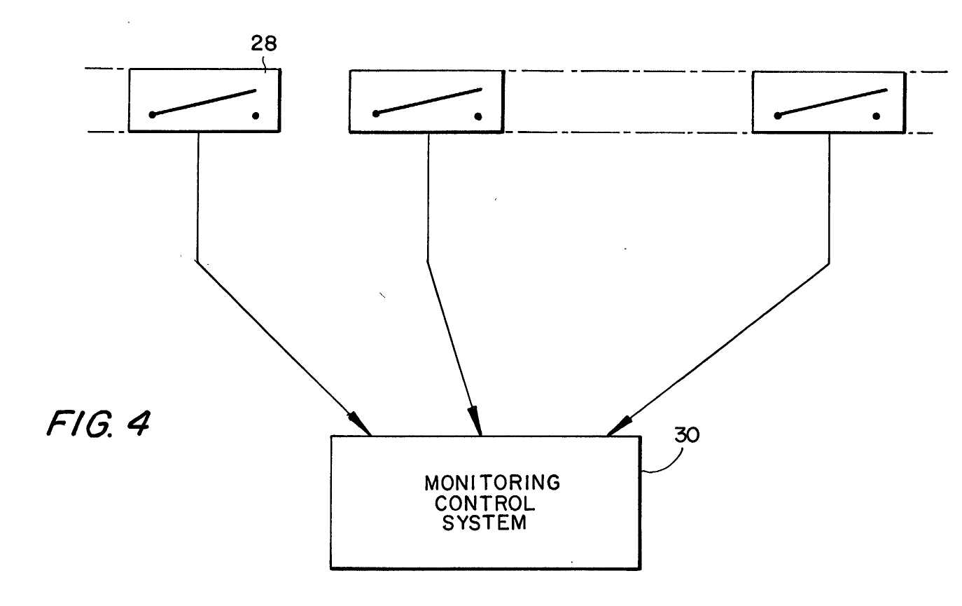

As depicted in FIG. 4, the status of the switches 28 may be monitored by a control system 30, which may be microprocessor driven. The monitoring and control system may include appropriate circuits and/or software to correlate the outputs of the individual pairs of switches at opposite ends of each deformable element, as well as to provide appropriate processing to determine if a valid signal is received, to distinguish the signal either from a transient condition or an intermittent contacts, to account for the passage of a force from deformable element to deformable element due to handrail travel, and to generate the appropriate alarms and/or controls to alert supervisory personnel, stop escalator travel, and the like.

I claim:

1. An escalator handrail load detection apparatus for use in an escalator having a moving handrail supported by a handrail guide, comprising:
a distortable element mounted to the handrail guide responsive to downward forces applied to the handrail; and
switch means associated with the distortable element for generating an output responsive to a minimum distortion of the distortable element corresponding to a specified minimum downward force to the handrail.

2. The load detection apparatus of claim 1 wherein the distortable element is mounted in a guide located on a top surface of the handrail guide.

3. The load detection apparatus of claim 1 or 2 further comprising a plate mounted to a top surface of the distortable element.

4. The load detection apparatus of claim 1 or 2 further comprising a low friction surface between the distortable element and the handrail guide.

5. The load detection apparatus of claim 3 wherein the low friction surface is a surface of an elongated force-distributing plate mounted to the distortable element.

6. The load detection apparatus of claim 5 wherein the plate is also a force-distributing plate.

7. The load detection apparatus of claim 6 wherein the plate is of stainless steel.

8. The load detection apparatus of claim 1 wherein the switch means comprise a pair of switches.

9. The load detection apparatus of claim 8 wherein the switches are located at opposite ends of the distortable element.

10. The load detection apparatus of claim 9 further comprising processing means coupled to the switches for determining when an alarm condition is present and generating an output in connection therewith.

11. An escalator handrail load detection apparatus for use in an escalator having a moving handrail supported by a handrail guide, comprising:
a plurality of distortable elements mounted seriatim along a length of the handrail guide, each distortable element being responsive to a downward force applied to the handrail above the element;
switch means associated with each of the distortable elements for generating an output responsive to a minimum distortion of the distortable element corresponding to a specified minimum downward force to the handrail; and
processing means coupled to the switches for interpreting the outputs of the switches and determining when an alarm condition exists as a result of an application of at least the minimum downward force to the handrail.
